(19) United States
(12) Patent Application Publication
(10) Pub. No.: US 2006/0070098 A1
(43) Pub. Date: Mar. 30, 2006

(54) Broadcast data receiver and broadcast data receiving method thereof

(75) Inventor: Akira Watanabe, Hannou-shi (JP)

Correspondence Address: COHEN, PONTANI, LIEBERMAN & PAVANE, 551 FIFTH AVENUE, SUITE 1210, NEW YORK, NY, 10176, US

(73) Assignee: Casio Hitachi Mobile Communications Co., Ltd., Tokyo (JP)

(21) Appl. No.: 11/235,349

(22) Filed: Sep. 26, 2005

(30) Foreign Application Priority Data
Sep. 28, 2004 (JP) 2004-281847

(51) Int. Cl. H04N 5/445; G06F 13/00; H04N 7/18; G06F 3/00

(52) U.S. Cl. 725/43; 725/41; 725/42; 725/58; 725/81

(57) ABSTRACT

When the EPG function key 251 is depressed, the operation judges whether or not an SD card 41 has been installed (Step S16). When an SD card 41 has been installed, the EPG screen is displayed which shows all the programs including copy controlled programs (Step S18). On the other hand, when an SD card 41 has not been installed, the program A3 which is a copy prohibited program becomes blurred and displayed such as the display 300 (Step S20). Also, when the TV function key 253 is depressed, the operation reverts to Step S10 and returns to the reception screen of a television program.

### CROSS-REFERENCE TO RELATED APPLICATION

This application is based upon and claims the benefit of priority from the prior Japanese Patent Application No. 2004-281847, filed Sep. 28, 2004, the entire contents of which is incorporated herein by reference.

### BACKGROUND OF THE INVENTION

1. Field of the Invention

The present invention relates to a broadcast data receiver and accompanying broadcast data receiving method compatible with a broadcast system which multiplexes and distributes, for example, Electronic Program Guide (EPG) broadcast data.

2. Description of the Related Art

In recent years, digital television broadcasting has been advancing very rapidly. For example, a presently known digital television broadcasting fee-based service scrambles (encrypts) the broadcast signal itself, such as disclosed in the conventional prior art of Japanese Laid-Open (Kokai) Patent Application No. 2004-096394 titled “TELEVISION RECEPTION SYSTEM, TELEVISION RECEIVER AND MOBILE TERMINAL.” The encryption cancellation data for descrambling (decrypting) the data stream is stored on a credit card-sized card furnished from the subscription-based pay TV service provider in advance. This card is installed into the subscriber's TV set-top box containing a tuner, which permits the party under contract to watch and/or record decrypted broadcasts (telecasts).

On the other hand, broadcast reception services have been considered for terrestrial wave digital broadcasting systems to television receivers of all display sizes including compact electronic apparatus, such as a cellular phone.

As for these broadcast reception services, although assumed that service can be received without a subscriber having to basically initiate a particular subscription request, only real-time reception is provided based on a portion of the broadcast contents (programs). Also, the case which prohibits recording and/or duplication because of copyright protection has been considered.

However, in the delivery method of the program guide data furnished by the present broadcast reception services, the subscriber is shown a display of the program guide data for each broadcast contents to which copyright protection is appended. Consequently, this presents subscribers with the prospective problem of not being able to comprehend which programs are either recording prohibited or duplication prohibited.

### SUMMARY OF THE INVENTION

The present invention has been made in view of the problem mentioned above. Accordingly, an object of the present invention is to provide a broadcast data receiver and accompanying broadcast data receiving method which enhances user-friendliness even if broadcast contents are received which have reception and copy restrictions (recording/duplication).

In order to solve this problem, a broadcast data receiver according to claim 1 comprises the following structure of a broadcast content reception section for receiving broadcast contents contained in a broadcast signal; a program guide reception section for receiving Electronic Program Guide data with control information appended which relates to recording for each broadcast contents name; a display section for displaying the Electronic Program Guide data received by the program guide reception section; a first recording section connected more removably attachable than the receiver main body; a first judgment section for judging whether or not the first recording section has been connected to the receiver to provide a judgment result; and a first display changing section for changing display modes of the Electronic Program Guide data displayed in the display section corresponding to the judgment result by the first judgment section.

In order to solve this problem, a broadcast data receiving method according to claim 11 constitutes the following steps. A broadcast contents reception step for receiving broadcast contents contained in a broadcast signal; a program guide reception step for receiving Electronic Program Guide data with control information appended which relates to recording for each broadcast contents name; a first judgment step for judging whether or not an external recording medium has been connected to provide a judgment result; and a first display changing step for changing display modes of the Electronic Program Guide data displayed in a display section corresponding to the judgment result by the first judgment step.

Further, in order to solve this problem, a broadcast data receiver according to claim 20 comprises the following configuration. A broadcast content reception means for receiving broadcast contents contained in a broadcast signal; a program guide reception means for receiving Electronic Program Guide data with control information appended which relates to recording for each broadcast contents name; a display means for displaying the Electronic Program Guide data received by the program guide reception means; a first recording means connected more removably attachable than the receiver main body; a first judgment means for judging whether or not the first recording means has been connected to the receiver TO PROVIDE A JUDGMENT RESULT; and a first display changing means for changing display modes of the Electronic Program Guide data displayed in the display means corresponding to the judgment result of the first judgment means.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing the configuration of a terrestrial digital television receiver 1 (cellular phone) according to the preferred embodiment of the present invention;

FIG. 2 is a conceptual diagram showing the data structure of an SD card 41;

FIG. 3 is a conceptual diagram showing the configuration of the memory area of a RAM 21;

FIG. 4 is a flow chart for explaining operation of the terrestrial digital television receiver 1 when performing a recording reservation according to the preferred embodiment;

FIG. 5 is a flow chart for explaining operation of the terrestrial digital television receiver 1 when performing a recording reservation according to the preferred embodiment;

FIG. 6 is a flow chart for explaining operation of the terrestrial digital television receiver 1 when performing a recording according to the preferred embodiment;

FIGS. 7A-7F are mimetic diagrams showing examples of the display screen of the terrestrial digital television receiver 1 according to the preferred embodiment; and

FIGS. 8A-8B are mimetic diagrams showing examples of the display screen of the digital terrestrial television receiver 1 according to the preferred embodiment.

### DETAILED DESCRIPTION OF THE PREFERRED EMBODIMENTS

Hereinafter, the preferred embodiments of the present invention will be described in detail with reference to the drawings.

### A. First Embodiment Configuration

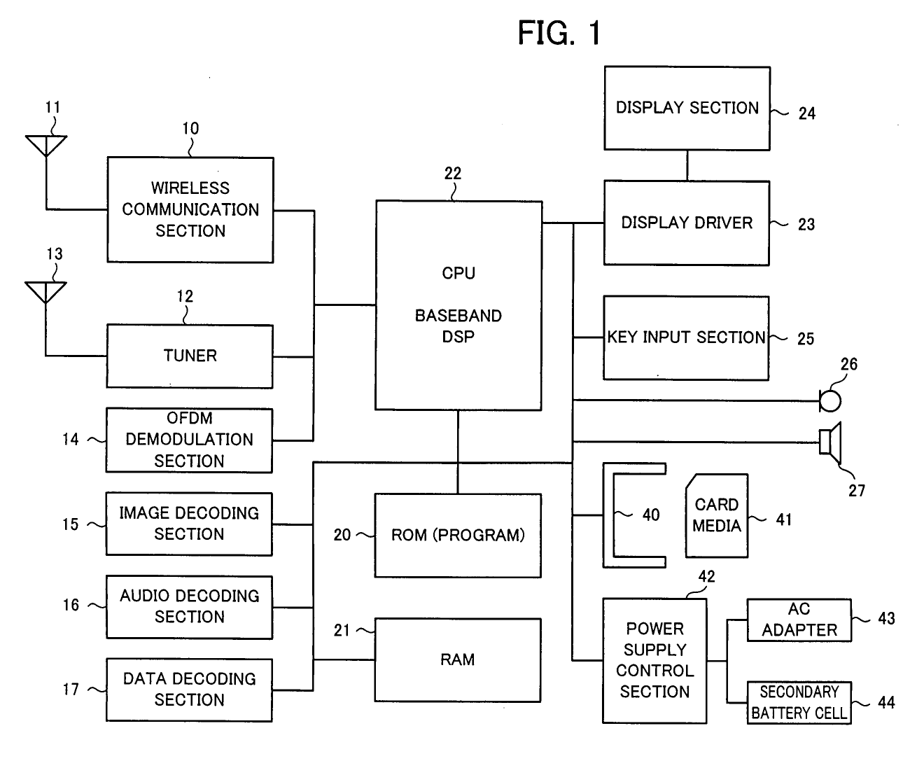

FIG. 1 is a block diagram showing the configuration of a terrestrial digital television receiver 1 (cellular phone) according to the preferred embodiment of the present invention. A wireless communication section 10 performs processing necessary for wireless communication, such as modulation/demodulation for sending/receiving audio and data (E-mail data) via an antenna 11 by wireless, modulation of audio and data, etc.

A tuner 12 receives BS (broadcast satellite)/terrestrial digital television broadcasts via an antenna 13 by wireless.

An OFDM demodulation section 14 performs demodulation of OFDM (orthogonal frequency division multiplexing) signals using the transmission technology of terrestrial digital television broadcasting.

An image decoding section 15 decodes the video signal demodulated by the OFDM demodulation section 14. An audio decoding section 16 decodes the audio signal demodulated by the OFDM demodulation section 14.

A data decoding section 17 decodes the data received by terrestrial digital television broadcasting. The television program guide data (hereinafter, denoted as “electronic program guide” or “EPG” for convenience) is also included in this data.

A ROM 20 stores various types of programs executed by a CPU 22. A RAM 21 stores E-mail data, an address book, the above-mentioned television program guide data, etc.

The CPU 22 executes the above-mentioned programs including a timing section 221 which clocks the current time and controls operation of each section of this apparatus.

Particularly, in the preferred embodiment, the operation judges whether or not an SD card 41 has been installed, which is an external recording medium described later.

Also, when setting the video recording reservation program selected from the electronic program guide as a video recording reservation and an SD card 41 is not installed, the display of the electronic program guide is controlled so that copy prohibited programs cannot be selected from among the programs listed in the above-mentioned program guide data.

Besides, when the program set as a recording reservation is a copy prohibited program, the CPU 22 encrypts the recorded program.

Furthermore, when an SD card 41 is not installed at the recording time of the program set as a recording reservation, the CPU 22 records the encrypted program in the RAM 21. Conversely, when an SD card 41 is installed, the encrypted program is recorded in the SD card 41.

A display driver 23 has a buffer corresponding to the display area of a display section 24 and drives the display section 24. The display section 24 may be composed of a 2.7 inch (240×428 dots) TFT color liquid crystal display (resolution of QVGA or HVGA) with video displayed in a 16:9 aspect ratio.

A key input section 25 is composed of various types of function keys, a ten-key pad, etc. A microphone 26 performs audio input.

A speaker 27 outputs audio for voice telephone calls, audio during television reception, etc.

A memory card slot 40 is furnished for installing (inserting) recording media, such as, an SD card 41, etc.

A power supply control section 42 normally supplies electrical power from a secondary battery cell 44 to each section. However, when an AC adapter 43 is connected, charge control of the above-mentioned secondary battery cell 44 is performed and the electrical power from a commercial power source is supplied to each section via the AC adapter 43.

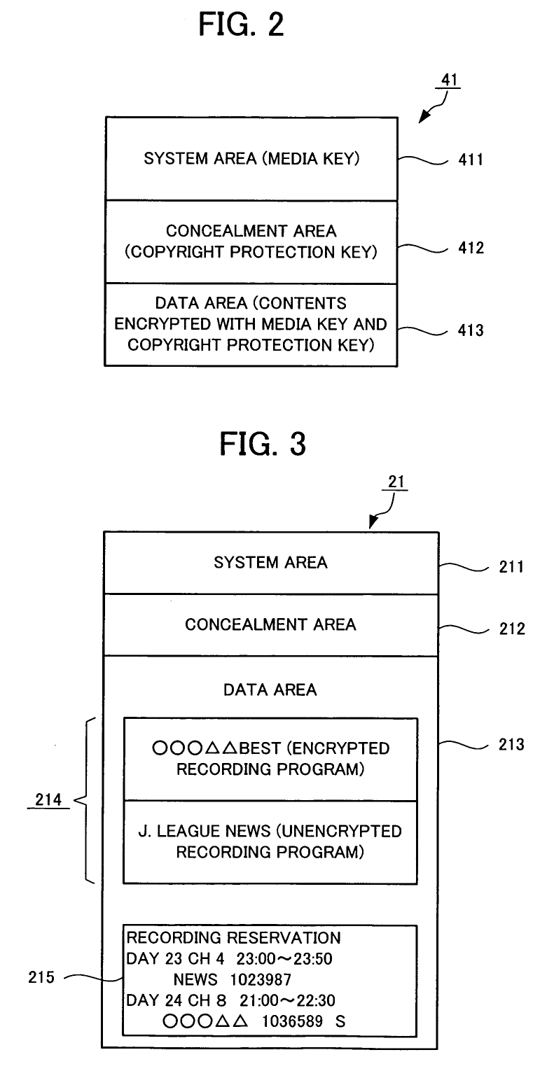

Next, FIG. 2 is a conceptual diagram showing the data structure of an SD card 41.

An SD card 41 has a system area 411, a concealment area 412 and a data area 413. The system area 411 contains the media key which is the characteristic identification information of the card itself. The concealment area 412 contains the copyright protection key of the programs (contents) sponsored by terrestrial digital television broadcasting.

Additionally, the data area 413 includes the media key and the copyright protection key of the contents encrypted by these keys.

Next, FIG. 3 is a conceptual diagram showing the configuration of the memory area of a RAM 21.

The RAM 21 has a system area 211, a concealment area 212 and a data area 213. The system area 211 contains data essential for operation of the terrestrial digital television receiver 1. The concealment area 212 contains the copyright protection key of the programs (contents) sponsored by terrestrial digital television broadcasting. The data area 213 contains recorded television program contents 214 and recording reservation data 215. From among the recorded television program contents 214, unencrypted data can be copied to an SD card 41 as well as copy prohibited data which remains encrypted. Additionally, the video recording reservation data 215 is composed of the date, channel, recording time slot, program name and the electronic program guide identification code. The letter “S” in FIG. 3 indicates a copy prohibited program, namely, a program which can be recorded only to an SD card 41.

### B. Operation of the Preferred Embodiment

Next, the operation of the preferred embodiment mentioned above will be explained.

B-1. Video Recording Reservation Operation

Initially, operation of the terrestrial digital television receiver 1 when performing a video recording reservation according to the preferred embodiment will be explained.

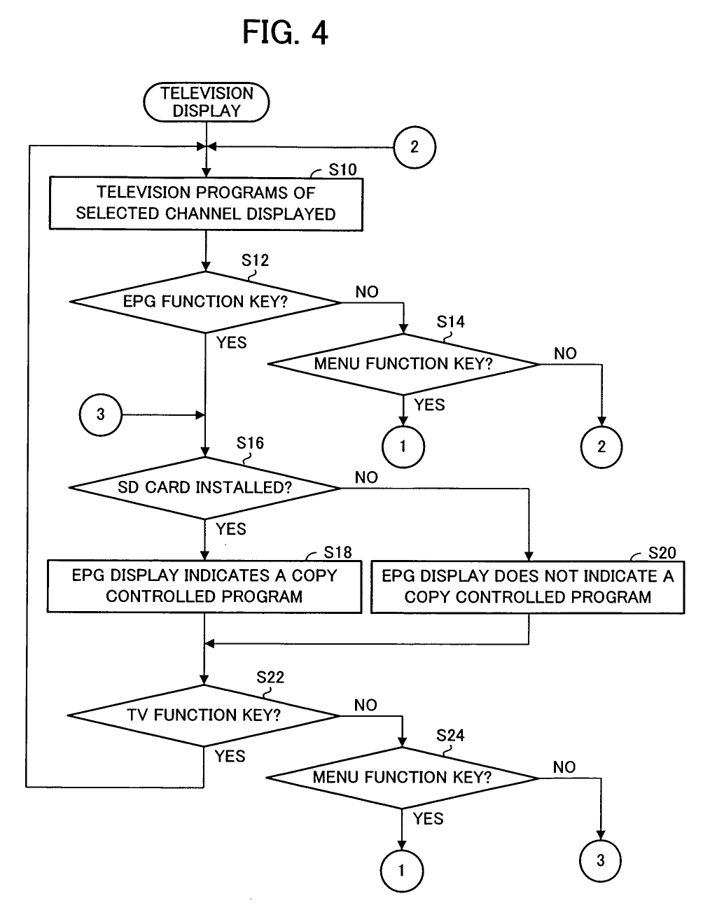

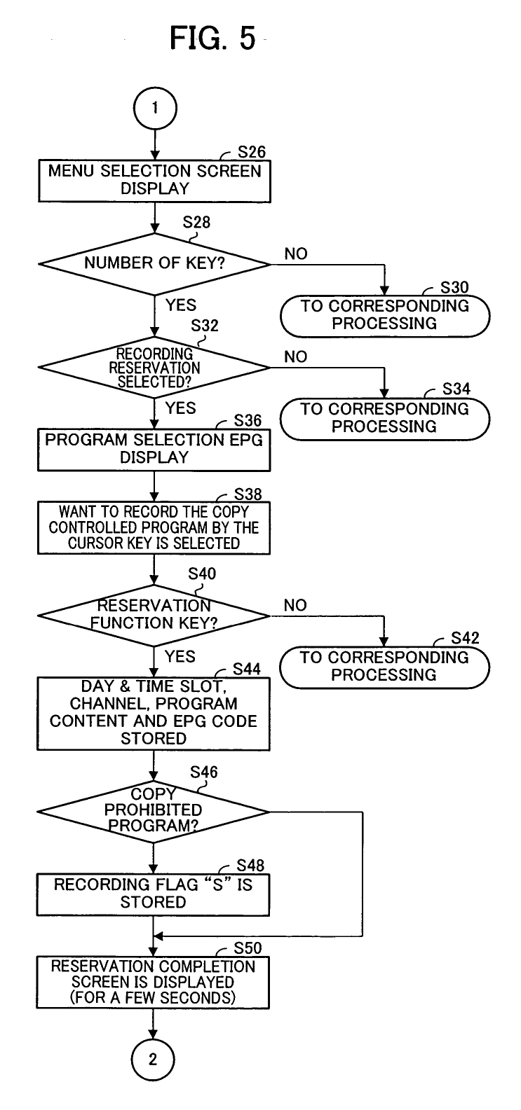

Here, FIG. 4 and FIG. 5 are flow charts for explaining operation of the terrestrial digital television receiver 1 when performing a recording reservation according to the preferred embodiment.

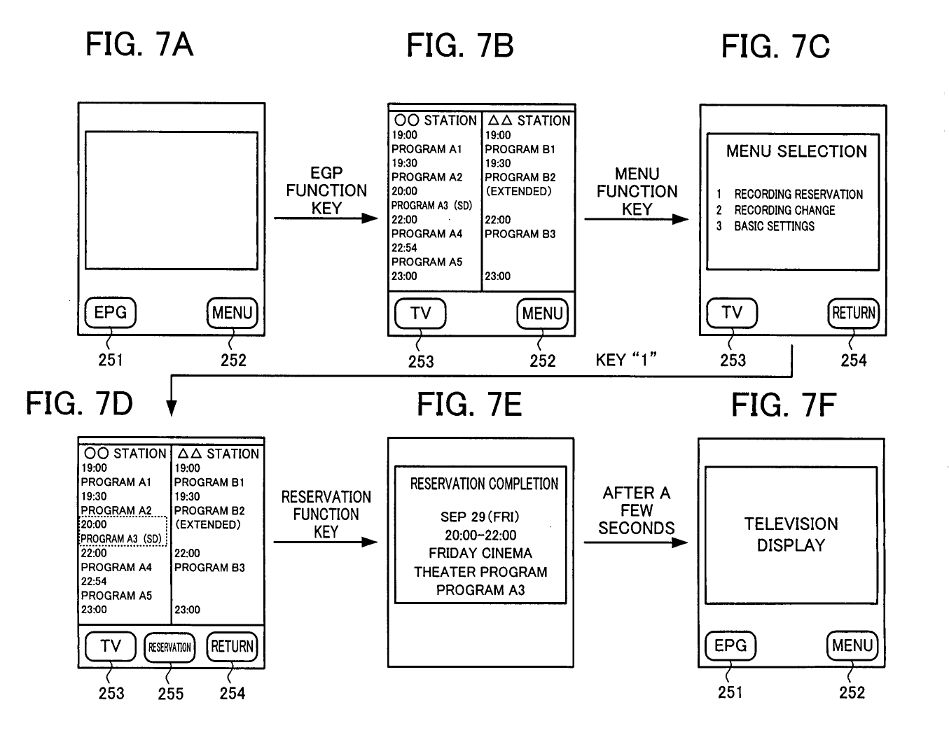

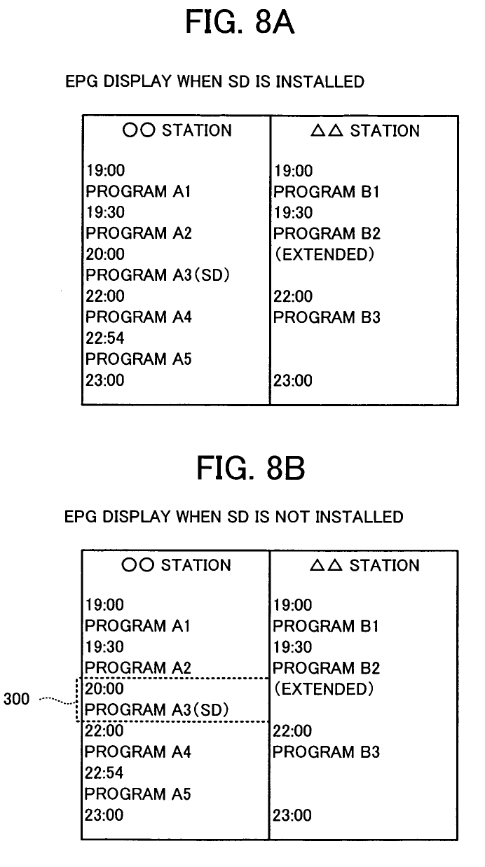

Besides, FIGS. 7A-7F and FIGS. 8A-8B are mimetic diagrams showing examples of the display screen of the terrestrial digital television receiver 1 according to the preferred embodiment.

First, in the terrestrial digital television receiver 1, while a television program of a selected channel is being received, as shown in FIG. 7A, the program is displayed in the display section 24 (Step S10).

In the television program reception screen, an EPG function key 251 for switching to display the program guide and a menu function key 252 for switching to display the menu screen described later are shown.

The menu function key 252 itself does not have a function as a button, but can be selected by depressing a function key of the key input section 25 that is near this button.

In this reception screen, the operation judges whether or not the EPG function key 251 has been depressed (Step S12) and, if not depressed, the operation judges whether or not the menu function key has been depressed (Step S14).

Then, if neither of these function keys have been depressed, the operation reverts to Step S10 and reception of a television program continues.

On the other hand, when the EPG function key 251 is depressed, the operation judges whether or not an SD card 41 has been installed (removably attachable) (Step S16).

When an SD card 41 has been installed, as shown in FIG. 8A, the EPG screen is displayed which shows all the programs including copy controlled programs (Step S18).

In the EPG program guide of FIG. 8A, the program A3 to which (SD) is appended indicates a copy prohibited program. On the other hand, when an SD card 41 has not been installed, as shown in FIG. 8B, the program A3 which is a copy prohibited program becomes blurred (illegible) and displayed such as the display 300 (Step S20). This blurred display 300 portion cannot be selected when choosing a recording program (a program to be recorded) described later.

In either of the above-situations, the EPG screen displays a TV function key 253 for returning to the reception screen of a television program and the menu function key 252 for switching to display the menu screen described later.

The corresponding soft button can be selected by depressing a predetermined function key of the key input section 25.

In the EPG screen, the operation judges whether or not the TV function key 253 has been depressed (Step S22) and, if not depressed, the operation judges whether or not the menu function key 252 has been depressed (Step S24).

Then, if neither of these function keys have been depressed, the operation reverts to Step S16 and display of the EPG screen for either FIG. 8A or FIG. 8B, as applicable, continues.

Conversely, when the TV function key 253 is depressed, the operation reverts to Step S10 and returns to the reception screen of a television program as shown in FIG. 7A.

Further, when the menu function key 252 has been depressed, a menu selection screen as seen in FIG. 7C is presented (Step S26).

In this menu selection screen, the subscriber can select any of the items of recording reservation, recording change and basic settings. These correspond to the ten-key pad numbers “1”, “2” and “3” of the key input section 25, respectively.

Also, in this menu selection screen, the TV function key 253 for returning to the reception screen of a television program and a return function key 254 for returning the EPG screen are displayed.

In the menu selection screen, the operation judges whether or not one of the above assigned numbers of the ten-key pad has been depressed (Step S28). When other than a ten-key pad number is depressed, namely, in the case of either of the TV function key 253 or the return function key 254, the operation advances to processing corresponding to the function key depressed, respectively (Step S30).

On the other hand, when one of the above assigned numbers of the ten-key pad is depressed, the operation judges whether or not the recording reservation, namely, the number “1” key, has been depressed (Step S32).

When other than recording reservation is selected, the operation advances to the corresponding processing of the selected item (Step S34).

Correspondingly, when recording reservation is selected, as seen in FIG. 7D, a program selection EPG screen for performing a recording reservation is displayed (Step S36).

This program selection EPG screen as mentioned above, depending on the existence of an installed SD card 41, the EPG screen of FIG. 8A or FIG. 8B is displayed.

The user selects a program to record from the EPG screen by operating a cursor menu key (omitted from diagram) of the key input section 25 in four-directions (cross type key) (Step S38).

At this stage, when an SD card 41 is installed, the user can select optional programs from among all the programs displayed on the EPG screen. However, when an SD card 41 is not installed, the program (blurred display 300) of a copy prohibited program cannot be selected.

Also, in the above-mentioned program selection EPG screen, the TV function key 253 for returning to the reception screen of a television program, a reservation function key 255 for setting a video recording reservation of a selected television program and the return function key 254 for returning the EPG screen are displayed.

In the program selection EPG screen, the operation judges whether or not the reservation function key 255 has been depressed (Step S40). When other than the reservation function key 255 is depressed, namely, in the case of either of the TV function key 253 or the return function key 254, the operation advances to processing corresponding to the function key depressed, respectively (Step S42).

Here, because this is not related to the essence of the present invention other than reservation, further explanation is omitted.

On the other hand, when the reservation function key 255 is selected, the recording reservation day & time slot, channel, program content and the EPG program code are stored in the data area 213 of the RAM 21 as recording reservation data 215 (Step S44).

Also, the operation judges whether or not the television program of the recording reservation is a copy prohibited program (Step S46). When judged a copy prohibited program, the recording will be annotated with a flag “S” which indicates the applicable program of the recording reservation data 215 can only be recorded with an SD card 41 (Step S48).

Next, as shown in FIG. 7E, a reservation completion screen is displayed (for a few seconds) which states that the reservation of the selected television program has been completed (Step S50). As shown in FIG. 7F, the operation then reverts to Step S10 which switches to the reception screen of a television program.

B-2 Recording Operation

Next, the operation of the terrestrial digital television receiver 1 when performing a video recording according to the preferred embodiment will be explained.

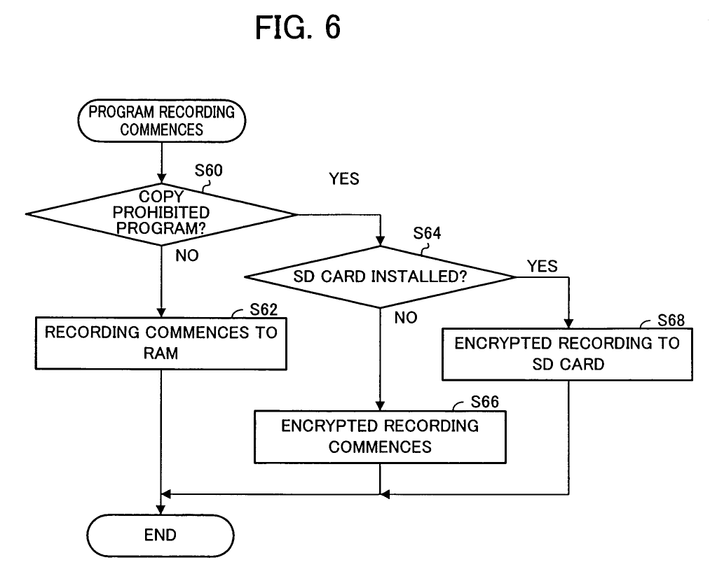

Here, FIG. 6 is a flow chart for explaining operation of the terrestrial digital television receiver 1 when performing a recording according to the preferred embodiment.

The CPU 22 monitors the recording reservation data 215 at predetermined time intervals based on the current time clocked by the timing section 221. The operation judges whether or not the current time constitutes the start recording time. When the start recording time arrives, a recording operation will be executed according to the flow chart shown in FIG. 6.

Initially, in the recording operation, the operation judges whether or not the recording reservation program which has reached recording time is a copy prohibited program (Step S60).

When a recording reservation program is not a copy prohibited program, as shown in FIG. 3, the operation will record the program without encryption to the data area 213 of the RAM 21 (Step S62).

On the other hand, when a recording reservation program is copy prohibited, the operation judges whether or not an SD card 41 is installed (Step S64). If an SD card 41 is not installed, as shown in FIG. 3, the operation encrypts and records to the data area 213 of the RAM 21 (Step S66).

In this case, the recorded program can be transferred to an SD card 41 afterwards by a move function (upon copying the recorded file from the main body to a recording medium, the recorded file of the main body side is erased).

On the other hand, when an SD card 41 is installed, as shown in FIG. 2, the operation will encrypt and record to the data area 413 of the SD card 41 (Step S68).

According to the first preferred embodiment mentioned above, when an SD card is not installed at the time of a recording reservation, reservation of a copy prohibited program is not permitted. In this manner, while eliminating wasteful operation and dealing with copy restrictions, this method enhances user-friendliness.

Besides, when an SD card is not installed at the time of a video recording, a copy prohibited program is encrypted and recorded in the main body which can only be copied one time to an external recording medium using a move function. Thus, this method is able to restrict copying to an external recording medium and practicable in coping with copy restrictions.

Additionally, in the preferred embodiment described above, although a terrestrial television receiver is explained, specifically, the present invention may be applied to a stationary television receiver, an in-vehicle television receiver and a cellular phone with a television receiving function.

Also, in the preferred embodiment, although the television program guide data (EPG data) is received via the antenna 13, the wireless communication section 10, the tuner 12, OFDM demodulation section 14 and the data decoding section 17, the present invention is not limited to this. The EPG data may be provided by a wireless communication service company and received via the antenna 11 and the wireless communication section 10.

Furthermore, in the preferred embodiment mentioned above, an SD card is explained as the external recording medium. However, not only can an SD card be used, but other recording medium as well, for example, Compact Flash (registered trademark) memory card, MultiMedia Card (MMC), etc.

Finally, in the preferred embodiment above, although copy restrictions are dealt with by discriminating whether or not an SD card has been installed, the present invention is not restricted to this. It may also be possible to deal with copy restrictions discriminating the external recording medium by a predetermined format or having a copy limitation function.

While the present invention has been described with reference to the preferred embodiments, it is intended that the invention be not limited by any of the details of the description therein but includes all the embodiments which fall within the scope of the appended claims.

What is claimed is:

1. A broadcast data receiver, comprising:
a broadcast content reception section for receiving broadcast contents contained in a broadcast signal;
a program guide reception section for receiving Electronic Program Guide data with control information appended which relates to recording for each broadcast contents name;
a display section for displaying said Electronic Program Guide data received by said program guide reception section;
a first recording section connected more removably attachable than said receiver main body;
a first judgment section for judging whether or not said first recording section has been connected to said receiver to provide a judgment result; and
a first display changing section for changing display modes of said Electronic Program Guide data displayed in said display section corresponding to said judgment result by said first judgment section.

2. The broadcast data receiver according to claim 1, further comprising:
an instruction section for instructing recording of each said received broadcast contents to said receiver;
a second judgment section for judging whether or not control information has been appended to said Electronic Program Guide data corresponding to said broadcast contents instructed by said instruction section to provide a judgment result; and
a first recording control section for controlling recording said broadcast contents to said first recording section for which said recording has been instructed based on said judgment result by said second judgment section and said judgment result by said first judgment section.

3. The broadcast data receiver according to claim 2, wherein said first recording control section records said broadcast contents to said first recording section when judged said control information has been appended corresponding to said broadcast contents by said second judgment section.

4. The broadcast data receiver according to claim 2, further comprising:
an encryption section for encrypting said received broadcast contents; and
said first recording control section records said broadcast contents encrypted by said encryption section to said first recording section when judged said control information has been appended corresponding to said broadcast contents by said second judgment section.

5. The broadcast data receiver according to claim 2, wherein said Electronic Program Guide said EACH broadcast contents name to which said control information has been appended and said each broadcast contents name to which said control information has not been appended are intermingled; and
said first display changing section displays said each broadcast contents name received by said program guide reception section as said Electronic Program Guide when judged said first recording section has been connected by said first judgment section and displays said each broadcast contents name to which said control information has not been appended as said Electronic Program Guide from among said each broadcast contents name received by said program guide reception section when judged said first recording section has not been connected by said first judgment section.

6. The broadcast data receiver according to claim 5, further comprising:
a second recording section which is mounted in the inner part of said receiver; and
a second recording control section for recording said broadcast contents to said second recording section when judged said control information has not been appended corresponding to said broadcast contents by said second judgment section.

7. The broadcast data receiver according to claim 6, wherein said Electronic Program Guide said each broadcast contents name is correspondingly appended with a broadcast start scheduled time and is settable;
said broadcast data receiver further comprising:
a timing section for clocking the current time;
a selection section for selecting said broadcast contents to be recorded when said Electronic Program Guide is displayed by said first display changing section;
a broadcast start time recording section for recording said broadcast start time of said broadcast contents selected by said selection section; and
said instruction section instructs a recording based on current time clocked by said timing section and said broadcast start time recorded in said broadcast start time recording section.

8. The broadcast data receiver according to claim 7, further comprising:
a third judgment section for judging whether or not control information has been appended to said each broadcast contents name selected by said selection section; and
a third recording control section for respectively recording said broadcast contents to said second recording section when judged said control information has been appended to said each broadcast contents name selected by said third judgment section and when judged said control information has not been appended to said each broadcast contents name of selected said broadcast contents in said first recording section.

9. The broadcast data receiver according to claim 8, further comprising:
a third display changing section for displaying said Electronic Program Guide based on contents recorded in said third recording control section when displaying said Electronic Program Guide in said display section.

10. The broadcast data receiver according to claim 2, wherein said first recording section comprises a first record area for recording copyright protection data and a second recording area for recording said broadcast contents which are correspondingly matched with said copyright protection data recorded in said first record area.

11. A broadcast data receiving method, comprising:
a broadcast contents reception step for receiving broadcast contents contained in a broadcast signal;
a program guide reception step for receiving Electronic Program Guide data with control information appended which relates to recording for each broadcast contents name;
a first judgment step for judging whether or not an external recording medium has been connected TO PROVIDE A JUDGMENT RESULT; and
a first display changing step for changing display modes of said Electronic Program Guide data displayed in a display section corresponding to said judgment result by said first judgment step.

12. The broadcast data receiving method according to claim 11, further comprising:
an instruction step for instructing recording of each said received broadcast contents;
a second judgment step for judging whether or not control information has been appended to said Electronic Program Guide data corresponding to said broadcast contents instructed by said instruction step to provide a judgment result; and
a first recording control step for controlling recording said broadcast contents to said external recording medium for which said recording has been instructed based on said judgment result by said second judgment step and said judgment result by said first judgment step.

13. The broadcast data receiving method according to claim 12, wherein said first recording control step records said broadcast contents to said external recording medium when judged said control information has been appended corresponding to said broadcast contents by said second judgment step.

14. The broadcast data receiving method according to claim 12, further comprising:
an encryption step for encrypting said received broadcast contents; and
said first recording control step records said broadcast contents encrypted by said encryption section to said external recording medium when judged said control information has been appended corresponding to said broadcast contents by said second judgment step.

15. The broadcast data receiving method according to claim 12, wherein said Electronic Program Guide said each broadcast contents name to which said control information has been appended and said each broadcast contents name to which said control information has not been appended are intermingled; and
said first display changing step displays said each broadcast contents name received by said program guide reception step as said Electronic Program Guide when judged said external recording medium has been connected by said first judgment step and displays said each broadcast contents name to which said control information has not been appended as said Electronic Program Guide from among said each broadcast contents name received by said program guide reception section when judged said external recording medium has not been connected by said first judgment step.

16. The broadcast data receiving method according to claim 15, further comprising:
a second recording control step for recording said broadcast contents to a recording medium of receiver inner part when judged said control information has not been appended corresponding to said broadcast contents by said second judgment step.

17. The broadcast data receiving method according to claim 16, wherein said Electronic Program Guide said each broadcast contents name has a correspondingly matching broadcast start scheduled time which is settable;
said broadcast data receiving method further comprising:
a timing step for clocking the current time;
a selection step for selecting said broadcast contents to be recorded when said Electronic Program Guide is displayed by said first display changing step;
a broadcast start time recording step for recording to predetermined memory said broadcast start time of said broadcast contents selected by said selection step; and
said instruction step instructs a recording based on current time clocked by said timing step and said broadcast start time recorded in said broadcast start time recording step.

18. The broadcast data receiving method according to claim 17, further comprising:
a third judgment step for judging whether or not control information has been appended to said each broadcast contents name selected by said selection step; and
a third recording control step for respectively recording said broadcast contents to said recording medium of receiver inner part when judged said control information has been appended to said each broadcast contents name selected by said third judgment step and when judged said control information has not been appended to said each broadcast contents name of selected said broadcast contents in said external recording medium.

19. The broadcast data receiving method according to claim 18, further comprising:
a third display changing step for displaying said Electronic Program Guide based on contents recorded in said third recording control step when displaying said Electronic Program Guide in said display section.

20. A broadcast data receiver, comprising:
a broadcast content reception means for receiving broadcast contents contained in a broadcast signal;
a program guide reception means for receiving Electronic Program Guide data with control information appended which relates to recording for each broadcast contents name;
a display means for displaying said Electronic Program Guide data received by said program guide reception means;
a first recording means connected more removably attachable than said receiver main body;
a first judgment means for judging whether or not said first recording means has been connected to said receiver to provide a judgment result; and
a first display changing means for changing display modes of said Electronic Program Guide data displayed in said display means corresponding to said judgment result of said first judgment means.
